(19) United States
(12) Patent Application Publication
(10) Pub. No.: US 2007/0298263 A1
(43) Pub. Date: Dec. 27, 2007

(54) Organic electroluminescence device and method for manufacturing same

(76) Inventors: Junichi Tonotani, Kanagawa-ken (JP); Masatoshi Higuchi, Kanagawa-ken (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/723,572

(22) Filed: Mar. 21, 2007

(30) Foreign Application Priority Data
Mar. 27, 2006 (JP) 2006-086382

(51) Int. Cl. B32B 27/00; B05D 5/12; B32B 27/32; B32B 9/04

(52) U.S. Cl. 428/421; 427/66; 428/411.1; 428/523

(57) ABSTRACT

A method for manufacturing an organic electroluminescence device includes: dissolving an organic material in a solvent to prepare an organic solution; forming an organic solution layer by coating a substrate with the organic solution; and forming an organic material layer by drying the organic solution layer. At least one of water concentration and oxygen concentration in the solvent is controlled to 100 mass ppm or less.

### CROSS-REFERENCE TO RELATED APPLICATIONS

This application is based upon and claims the benefit of priority from the prior Japanese Patent Application No. 2006-086382, filed on Mar. 27, 2006; the entire contents of which are incorporated herein by reference.

### BACKGROUND OF THE INVENTION

1. Field of the Invention

This invention relates to an organic electroluminescence device and a method for manufacturing the same, and more particularly to an organic electroluminescence device and a method for manufacturing the same where an organic material layer is formed by dissolving an organic material in a solvent.

2. Background Art

The organic electroluminescence device (hereinafter also referred to as “organic EL device”) is a self-emitting device that can be manufactured by a low-temperature, large-area process, and hence is promising for application to next-generation thin film displays.

An organic EL device has an organic luminescent layer sandwiched between an anode and a cathode, the organic luminescent layer having electrical conductivity and luminescence. By applying a forward voltage between the anode and the cathode, holes are injected from the anode into the organic luminescent layer, and electrons are injected from the cathode into the organic luminescent layer. The hole and the electron are recombined in the organic luminescent layer to generate an exciton, which releases excess energy as light during relaxation. Typically in an organic EL device, for adjusting the injection level and the mobility of electrons and holes injected from the electrodes, several organic layers including a hole injection layer, a hole transport layer, an electron transport layer, and an electron injection layer made of organic materials are provided in addition to the organic luminescent layer between the anode and the cathode.

These organic layers include those formed from small-molecular organic materials and those formed from macro-molecular organic materials. Organic layers made of small-molecular organic materials are typically deposited by vacuum evaporation, which is less adaptable to large-area processing and increases cost. Macro-molecular organic materials are easily soluble in some solvents. Thus organic layers made of macro-molecular organic materials can be formed by low-cost processes adaptable to large-area processing such as printing and ink jet techniques (see, e.g., JP 2004-055279A).

However, because organic EL devices are based on organic materials, they are susceptible to alteration of organic molecular structures due to moisture and alteration of materials or material interfaces associated with electric current driving. Thus, unfortunately, organic EL devices have a short lifetime for use as luminescent devices. In particular, organic EL devices made of macro-molecular organic materials have a shorter lifetime than organic EL devices made of small-molecular organic materials.

### SUMMARY OF THE INVENTION

According to an aspect of the invention, there is provided a method for manufacturing an organic electroluminescence device, including: dissolving an organic material in a solvent to prepare an organic solution; forming an organic solution layer by coating a substrate with the organic solution; and forming an organic material layer by drying the organic solution layer, at least one of water concentration and oxygen concentration in the solvent being controlled to 100 mass ppm or less.

According to another aspect of the invention, there is provided an organic electroluminescence device manufactured by the method including: dissolving an organic material in a solvent to prepare an organic solution; forming an organic solution layer by coating a substrate with the organic solution; and forming an organic material layer by drying the organic solution layer, at least one of water concentration and oxygen concentration in the solvent being controlled to 100 mass ppm or less.

### BRIEF DESCRIPTION OF THE DRAWINGS

FIG. 1 is a cross-sectional view illustrating an organic EL device manufactured in an embodiment of the invention.

FIG. 2 is a flow chart illustrating a method for manufacturing an organic EL device according to this embodiment.

FIGS. 3 to 6 are graphs showing the temporal variation of organic EL devices, where the horizontal axis represents operating time, and the vertical axis represents luminescence brightness and driving voltage. The solvent is dehydrated xylene in FIG. 3, normal xylene in FIG. 4, dehydrated tetralin in FIG. 5, and normal tetralin in FIG. 6.

FIG. 7 is a graph comparing the luminescence brightness with each other for a operating time of 200 hours in the measurement results shown in FIGS. 3 to 6.

### DETAILED DESCRIPTION OF THE INVENTION

An embodiment of the invention will now be described with reference to the drawings.

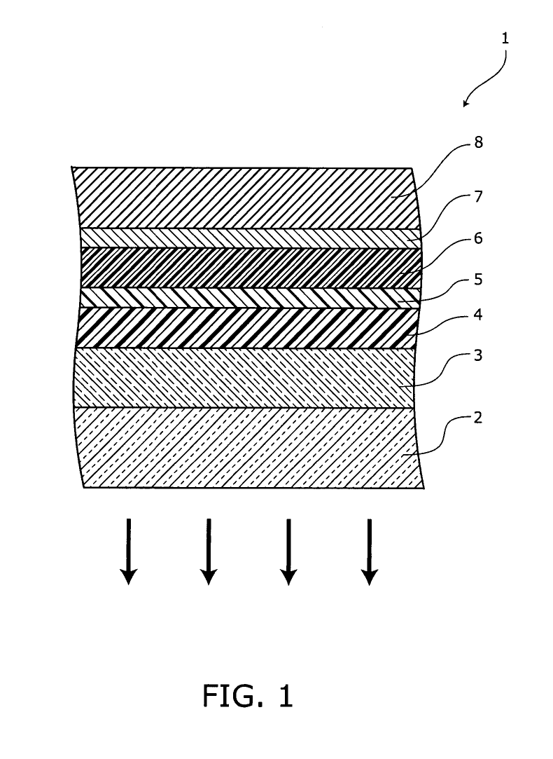

FIG. 1 is a cross-sectional view illustrating an organic EL device manufactured in an embodiment of the invention.

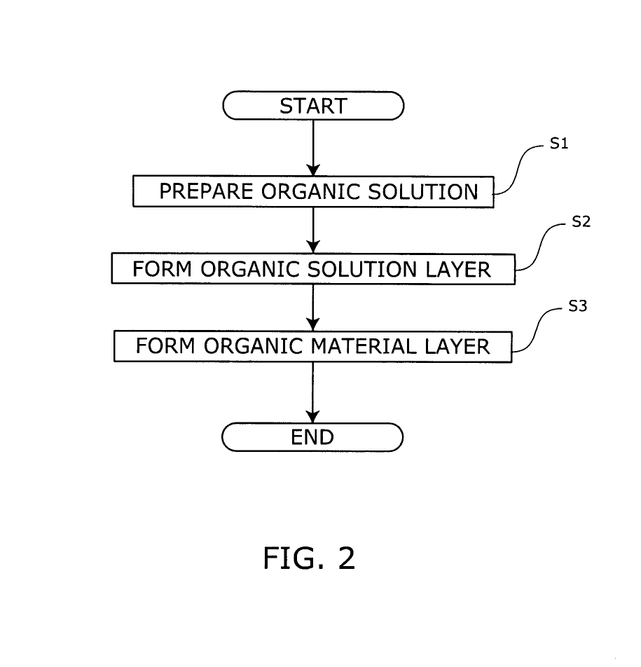

FIG. 2 is a flow chart illustrating a method for manufacturing an organic EL device according to this embodiment.

First, as shown in FIG. 1, a transparent substrate 2 illustratively made of glass is prepared. A film of transparent conductive material such as ITO (indium tin oxide) is grown on the transparent substrate 2 to form an anode 3. Next, the anode 3 is coated with an aqueous solution of PEDOT (poly(ethylenedioxy)thiophene): PSS (polystyrene sulfonate) and dried to form a hole transport layer 4. Next, an electron blocking layer 5 illustratively made of polyfluorene-based material is formed.

Next, a luminescent layer 6 is formed. To this end, as shown in step S1 of FIG. 2, an organic material such as a polyfluorene-based material is dissolved in a solvent to prepare an organic solution. That is, the organic material is formed into an ink. The solvent is illustratively one organic solvent or a mixed solvent of two or more organic solvents selected from the group consisting of (e.g.) tetralin, xylene, and toluene. The concentration of the organic material in the organic solution may be adjusted so that the organic solution has a viscosity suitable for coating, and is illustratively 1 mass %.

Here, instead of polyfluorene-based material, the luminescent layer 6 can be made of PPV (poly(phenylene vinylene)). In this case, PPV can be dissolved in a solvent using a condition and procedure similar to those for polyfluorene-based material to prepare an organic solution. As in the case of polyfluorene-based material, the solvent is illustratively one organic solvent or a mixed solvent of two or more organic solvents selected from the group consisting of tetralin, xylene, and toluene. The concentration of the organic material in the organic solution may be adjusted so that the organic solution has a viscosity suitable for coating.

The solvent used is controlled so that at least one of the water concentration and the oxygen concentration is 100 mass ppm or less. Preferably, the water concentration and the oxygen concentration in this solvent are each 100 mass ppm or less. In particular, more preferably, at least one of the water concentration and the oxygen concentration in this solvent is not more than the water concentration or the oxygen concentration in the atmosphere where the step of forming an organic solution layer shown in step S2 and the step of forming an organic material layer shown in step S3 described later are performed, e.g., the atmosphere in a glove box where these steps are performed. Typically, the atmosphere in a glove box where coating and baking are performed is a dry nitrogen atmosphere from which water and oxygen are removed by activated carbon and metal catalyst, respectively. In this atmosphere, the water concentration and the oxygen concentration are each illustratively 1 mass ppm or less, more specifically 0.1 mass ppm or less. Thus the water concentration and the oxygen concentration in the solvent are preferably 1 mass ppm or less, and more preferably 0.1 mass ppm or less.

Next, as shown in step S2, the electron blocking layer 5 is coated with the prepared organic solution to form a liquid organic solution layer. As described above, this step is performed in a dry nitrogen atmosphere where the water concentration and the oxygen concentration are each controlled to e.g. 1 mass ppm or less.

Next, as shown in step S3, the applied organic solution layer is baked at a temperature of e.g. 100 to 200° C. for drying. Thus the solvent in the organic solution layer is volatilized away, and a solid organic material layer is formed. This organic material layer is the luminescent layer 6 shown in FIG. 1. This step is also performed, like the step shown in step S2, in a dry nitrogen atmosphere where the water concentration and the oxygen concentration are each controlled to e.g. 1 mass ppm or less. The drying step shown in step S3 can also be performed by the so-called “vacuum baking”. That is, the substrate on which an organic solution layer is formed by the coating step shown in step S2 can be exposed to an atmosphere (e.g. inert gas of nitrogen) having reduced pressure to remove the solvent from the organic solution layer.

After the luminescent layer 6 is formed, an electron injection layer 7 illustratively made of CsF (cesium fluoride), Ca (calcium), Ba (barium), or LiF (lithium fluoride) is formed. Then a cathode 8 made of metal such as Al (aluminum) is formed. Thus an organic EL device 1 according to this embodiment is manufactured. More specifically, this organic EL device 1 has an anode 3, a hole transport layer 4, an electron blocking layer 5, a luminescent layer 6, an electron injection layer 7, and a cathode 8 laminated in this order on a transparent substrate 2.

In the organic EL device 1 thus manufactured, when a voltage is applied between the anode 3 and the cathode 8, holes are injected from the anode 3 through the hole transport layer 4 and the electron blocking layer 5 into the luminescent layer 6, and electrons are injected from the cathode 8 through the electron injection layer 7 into the luminescent layer 6. In the luminescent layer 6, the injected hole and electron are recombined to generate an exciton, which emits light during relaxation. A portion of this light travels directly toward the anode 3. The other portion travels toward the cathode 8, which is the opposite electrode, and is reflected from the cathode 8 toward the anode 3. Then the light passes through the anode 3, which is a transparent electrode, and through the transparent substrate 2 and is emitted outside the organic EL device 1.

In this embodiment, by controlling the concentration of water and oxygen in the solvent used in forming the luminescent layer 6 as described above, the lifetime of the organic EL device 1 can be extended. The purity of materials is one possible cause of the fact that the lifetime of organic EL devices made of macro-molecular materials is shorter than devices made of small-molecular materials. More specifically, with regard to a small-molecular material, the purity is improved by repeated sublimation purification, and then a film thereof is grown by vapor deposition under high vacuum. Thus impurities in the material and water mixed in from the environment are kept at an extremely low level. In contrast, with regard to a macro-molecular material, its purification is difficult, and water and oxygen are easily mixed in the material. Thus, presumably, the organic material constituting the luminescent layer 6 is deteriorated by water and oxygen contained therein, and hence the characteristics of the organic EL device are deteriorated.

According to experimental studies aimed at extending the lifetime of organic EL devices, the inventors have found that water and oxygen in the solvent for dissolving organic materials to form the organic material layer greatly affects the lifetime of the manufactured organic EL device. The inventors have discovered that the lifetime of an organic EL device is extended by using a solvent in which at least one of the water concentration and the oxygen concentration is 100 mass ppm or less. Preferably, the water concentration and the oxygen concentration in this solvent are each 100 mass ppm or less. It is more effective when these concentrations are not more than the water concentration and the oxygen concentration in the atmosphere where the organic solution is applied and dried. More specifically, the water concentration and the oxygen concentration in the solvent are preferably 1 mass ppm or less, and more preferably 0.1 mass ppm or less.

Currently, it is not clear how water and oxygen in the solvent affect the deterioration of the organic material. However, the following mechanism is conjectured. The organic material is dissolved in the solvent to prepare an organic solution, which is then dried to form an organic material layer. Then most of the solvent molecules are evaporated away from the organic material layer, but some solvent molecules are enclosed in the polymers of the organic material and remain in the organic material layer. Here, if water or oxygen is mixed in the solvent, the water or oxygen is also captured in the polymers of the organic material and remain in the organic material layer. The residual water hydrolyzes the polymer constituting the organic material layer, for example, and the residual oxygen breaks bonds in the polymer under irradiation with light. Thus water and oxygen in the solvent deteriorate the organic material. In particular, the initial stage of such deterioration presumably advances during baking the organic solution layer.

The invention has been described with reference to the embodiment. However, the invention is not limited to the above embodiment, but can be variously modified by those skilled in the art. Such modifications are also encompassed within the scope of the invention as long as they include the features of the invention.

For example, in this embodiment, the water concentration and/or the oxygen concentration in the solvent used in forming the luminescent layer is illustratively controlled. However, the invention is not limited thereto. When a layer other than the luminescent layer is formed by using a solvent, the water concentration and/or the oxygen concentration in this solvent can be controlled as described above. In this case again, a similar effect can be achieved as described above. For example, the electron blocking layer can be formed by using a solvent where the water concentration and the oxygen concentration are controlled.

In this embodiment, a macro-molecular material is illustratively used as an organic material dissolved in the solvent. However, the invention is not limited thereto. A small-molecular material can also be used if it is an organic material diluted in a solvent when used.

Furthermore, the layer configuration of the organic EL device manufactured according to the invention is not limited to the layer configuration illustrated in FIG. 1. Layers not shown in FIG. 1 can be added, and some of the layers shown in FIG. 1 can be omitted.

Moreover, the material forming each layer is not limited to the material illustrated in the above embodiment.

### EXAMPLES

The effect of examples of the invention is described in comparison with comparative examples in detail.

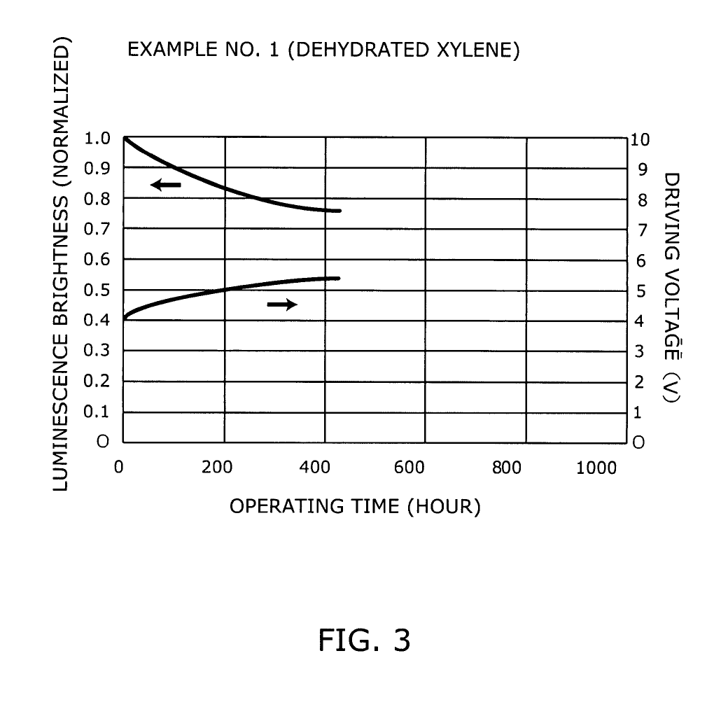

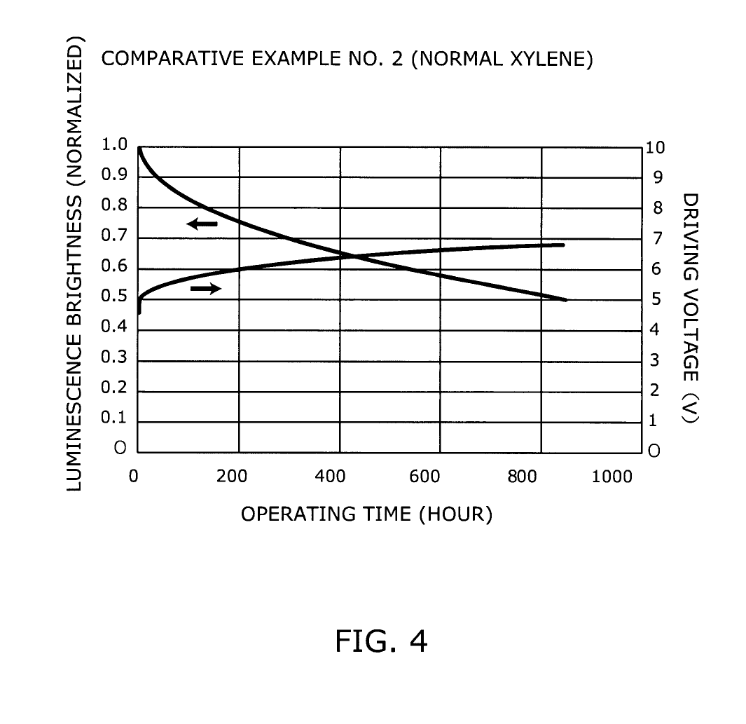

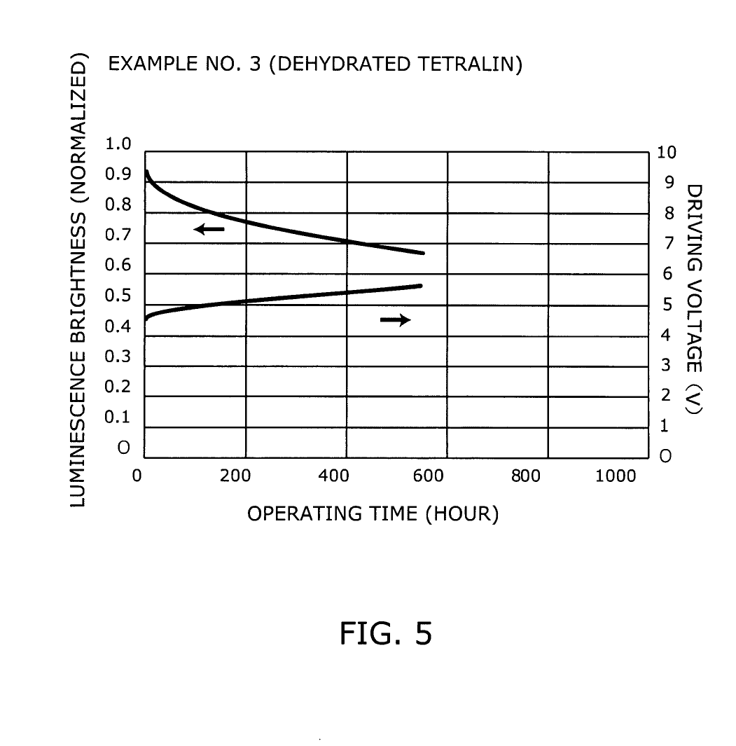

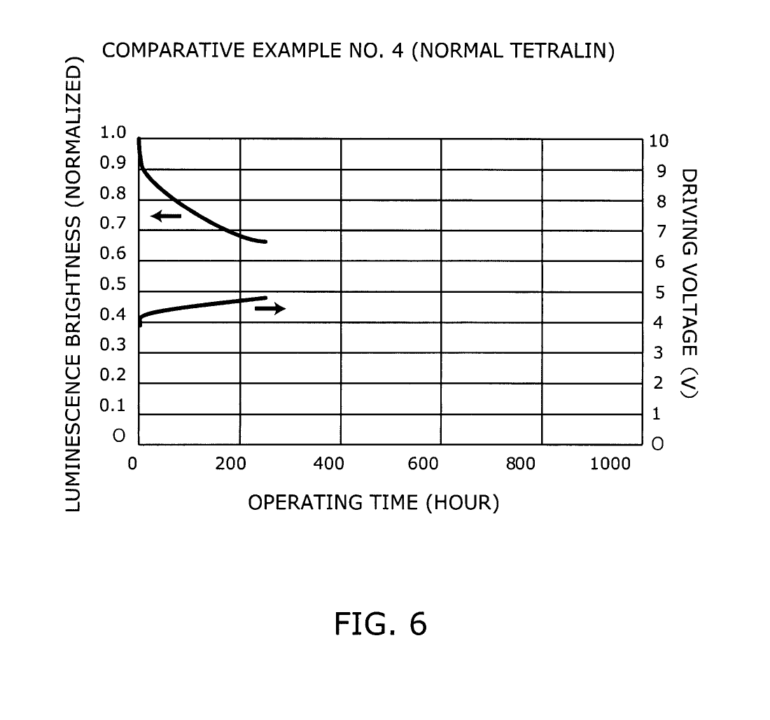

FIGS. 3 to 6 are graphs showing the temporal variation of organic EL devices, where the horizontal axis represents operating time, and the vertical axis represents luminescence brightness and driving voltage. FIG. 3 shows the case where the solvent is dehydrated xylene. FIG. 4 shows the case where the solvent is normal xylene. FIG. 5 shows the case where the solvent is dehydrated tetralin. FIG. 6 shows the case where the solvent is normal tetralin. Here, in each figure, the left vertical axis represents the normalized value of luminescence brightness with reference to the value at the beginning of luminescence. The right vertical axis represents the driving voltage.

First, four organic EL devices were manufactured by the method described in the above embodiment. Here, the solvent used in forming the luminescent layer was varied among the organic EL devices. TABLE 1 shows the type and the water concentration in the solvent used for each organic EL device. For continuous luminescence, a current was passed through these organic EL devices so as to maintain a current density of 8 mA/cm². Here, the variation of the luminescence brightness and the required driving voltage was measured. As the organic EL device is deteriorated, the luminescence brightness decreases, and the driving voltage increases.

TABLE 1

| | | Solvent | |
|---|---|---|---|
| | | | Water concentration |
| | No. | Type | (mass ppm) |
| Example | 1 | Dehydrated xylene | Not more than 30 |
| Comparative | 2 | Normal xylene | More than 100 and not more |
| Example | | | than 200 |
| Example | 3 | Dehydrated tetralin | Not more than 50 |
| Comparative | 4 | Normal tetralin | More than 100 and not more |
| Example | | | than 500 |

As shown in FIGS. 3 and 4, the organic EL device according to Example No. 1, that is, the organic EL device manufactured by using xylene having a water concentration of 30 mass ppm or less (dehydrated xylene), exhibited a more gradual decrease of luminescence brightness and a more gradual increase of driving voltage than the organic EL device according to Comparative Example No. 2, that is, the organic EL device manufactured by using xylene having a water concentration of more than 100 mass ppm and not more than 200 mass ppm (normal xylene). That is, the organic EL device according to Example No. 1 was less deteriorated than the organic EL device according to Comparative Example No. 2.

As shown in FIGS. 5 and 6, the organic EL device according to Example No. 3, that is, the organic EL device manufactured by using tetralin having a water concentration of 50 mass ppm or less (dehydrated tetralin), exhibited a more gradual decrease of luminescence brightness and a more gradual increase of driving voltage than the organic EL device according to Comparative Example No. 4, that is, the organic EL device manufactured by using tetralin having a water concentration of more than 100 mass ppm and not more than 500 mass ppm (normal tetralin). That is, the organic EL device according to Example No. 3 was less deteriorated than the organic EL device according to Comparative Example No. 4.

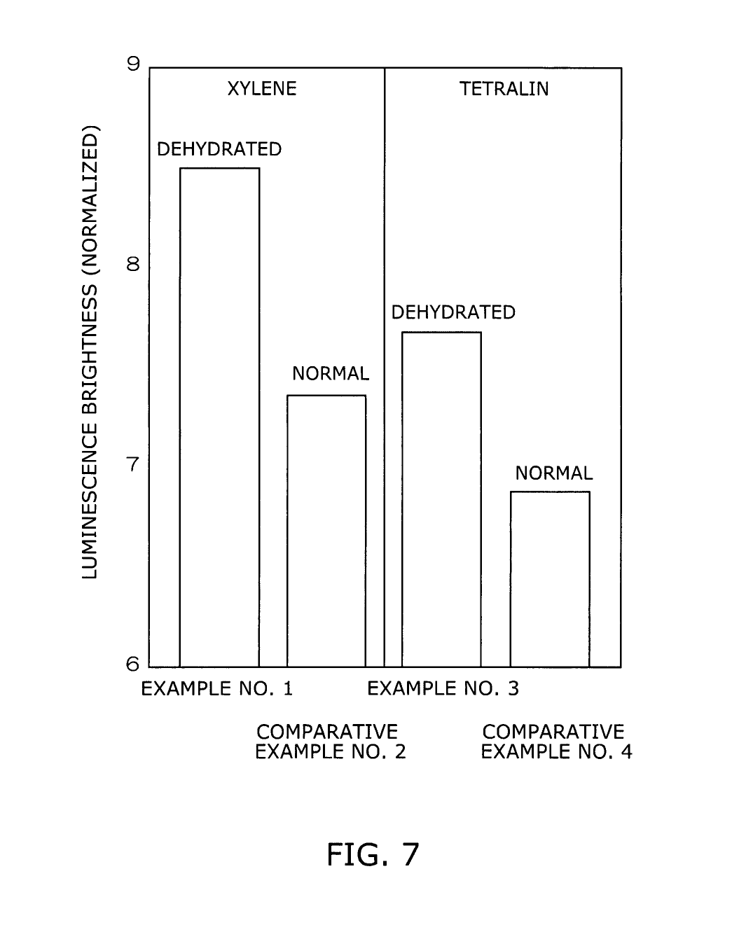

FIG. 7 is a graph comparing the normalized value of luminescence brightness with each other for a operating time of 200 hours in the measurement results shown in FIGS. 3 to 6. As shown in FIGS. 3 to 7, the deterioration of organic EL devices was reduced by using solvents having a water concentration of 100 ppm or less in forming the luminescent layer as compared with the case of using solvents having a water concentration of more than 100 ppm.

1. A method for manufacturing an organic electroluminescence device, comprising:
dissolving an organic material in a solvent to prepare an organic solution;
forming an organic solution layer by coating a substrate with the organic solution; and
forming an organic material layer by drying the organic solution layer,
at least one of water concentration and oxygen concentration in the solvent being controlled to 100 mass ppm or less.

2. The method for manufacturing an organic electroluminescence device according to claim 1, wherein the water concentration and the oxygen concentration in the solvent are each 100 mass ppm or less.

3. The method for manufacturing an organic electroluminescence device according to claim 1, wherein the water concentration or the oxygen concentration in the solvent is not more than the water concentration or the oxygen concentration in an atmosphere where the step of forming an organic solution layer and the step of forming an organic material layer are performed.

4. The method for manufacturing an organic electroluminescence device according to claim 1, wherein at least one of the water concentration and the oxygen concentration in the solvent is 1 mass ppm or less.

5. The method for manufacturing an organic electroluminescence device according to claim 4, wherein at least one of the water concentration and the oxygen concentration in the solvent is 0.1 mass ppm or less.

6. The method for manufacturing an organic electroluminescence device according to claim 1, wherein the solvent is one organic solvent or a mixed solvent of two or more organic solvents selected from the group consisting of tetralin, xylene, and toluene.

7. The method for manufacturing an organic electroluminescence device according to claim 1, wherein the organic material layer is a luminescent layer.

8. The method for manufacturing an organic electroluminescence device according to claim 1, wherein the organic material is a polyfluorene-based material.

9. The method for manufacturing an organic electroluminescence device according to claim 1, wherein the organic material is a polyphenylene vinylene.

10. The method for manufacturing an organic electroluminescence device according to claim 1, wherein the water concentration and the oxygen concentration in the solvent are each 1 mass ppm or less.

11. An organic electroluminescence device manufactured by the method comprising:
dissolving an organic material in a solvent to prepare an organic solution;
forming an organic solution layer by coating a substrate with the organic solution; and
forming an organic material layer by drying the organic solution layer,
at least one of water concentration and oxygen concentration in the solvent being controlled to 100 mass ppm or less.

12. The organic electroluminescence device according to claim 1, wherein the water concentration and the oxygen concentration in the solvent are each 100 mass ppm or less.

13. The organic electroluminescence device according to claim 1, wherein the water concentration or the oxygen concentration in the solvent is not more than the water concentration or the oxygen concentration in an atmosphere where the step of forming an organic solution layer and the step of forming an organic material layer are performed.

14. The organic electroluminescence device according to claim 1, wherein at least one of the water concentration and the oxygen concentration in the solvent is 1 mass ppm or less.

15. The organic electroluminescence device according to claim 4, wherein at least one of the water concentration and the oxygen concentration in the solvent is 0.1 mass ppm or less.

16. The organic electroluminescence device according to claim 1, wherein the solvent is one organic solvent or a mixed solvent of two or more organic solvents selected from the group consisting of tetralin, xylene, and toluene.

17. The organic electroluminescence device according to claim 1, wherein the organic material layer is a luminescent layer.

18. The organic electroluminescence device according to claim 1, wherein the organic material is a polyfluorene-based material.

19. The organic electroluminescence device according to claim 1, wherein the organic material is a polyphenylene vinylene.

20. The organic electroluminescence device according to claim 1, wherein the water concentration and the oxygen concentration in the solvent are each 1 mass ppm or less.
